(19) United States
(12) Patent Application Publication
(10) Pub. No.: US 2009/0056866 A1
(43) Pub. Date: Mar. 5, 2009

(54) SUBSTRATE BONDING APPARATUS AND METHOD

(76) Inventors: Jae Seok HWANG, Seongnam-si (KR); Sung Kwon HWANGBO, Gumi-si (KR)

Correspondence Address: KED & ASSOCIATES, LLP, P.O. Box 221200, Chantilly, VA, 20153-1200, US

(21) Appl. No.: 12/132,051

(22) Filed: Jun. 3, 2008

(30) Foreign Application Priority Data
Sep. 3, 2007 (KR) 10-2007-0088996
Sep. 20, 2007 (KR) 10-2007-0095748

(51) Int. Cl. B32B 38/10; B32B 37/00

(52) U.S. Cl. 156/249; 156/381; 156/536; 156/499

(57) ABSTRACT

A substrate bonding apparatus including a first chamber including a first surface plate on which a first substrate is received, a surface plate lift for lifting the first surface plate, a second chamber including a second surface plate on which a second substrate to be bonded to the first substrate is received, at least one adhesive included with the first surface plate to adhere to the first substrate, and an adhesive lift for independently lifting the adhesive.

### BACKGROUND

1. Field

One or more embodiments described herein relate to bonding substrates.

2. Background

Various flat display devices are now available on the market. Among these, LCDs produce excellent image quality and are light in weight, thin in thickness, and low in power consumption compared with other devices. LCDs are made by injecting liquid crystal between a thin film transistor (TFT) substrate and a color filter (CF) substrate. Processes used to bond these substrates have drawbacks that in crease costs and adversely affect performance.

### BRIEF DESCRIPTION OF THE DRAWINGS

FIG. 1 is a diagram showing one embodiment of a substrate bonding apparatus.

FIG. 2 is a diagram showing an enlarged view of a substrate chuck included in the apparatus of FIG. 1.

FIGS. 3 to 6 are diagrams showing examples of an adhesive.

FIGS. 7 and 8 are flowcharts showing steps included in various embodiments of a substrate bonding method.

FIGS. 9 and 10 are diagrams showing how substrate chucks in accordance with the foregoing embodiments may operate.

FIG. 11 is a diagram showing another embodiment of a substrate bonding apparatus.

FIG. 12 is a plan view of a substrate chuck that may be used in FIG. 11.

FIGS. 13 and 14 are diagrams showing the configuration and operation of the substrate chuck in FIGS. 11 and 12.

FIGS. 15 to 18 are diagrams showing arrangements of an adhesive that may be used in an apparatus in accordance with the embodiments described herein.

FIGS. 19 and 20 are diagrams showing other examples of a substrate chuck.

### DETAILED DESCRIPTION

An LCD may be manufactured using a variety of processes. For example, one process involves preparing a TFT substrate and a CF substrate, another process involves bonding the two substrates, and yet another process involves injecting liquid crystal material into a space between the substrates. The process of bonding the two substrates is one of the most important processes that determines the quality and performance of the LCD.

The substrate bonding process may be carried out by a substrate bonding apparatus that includes an upper chamber and a lower chamber that define an intervening space where a vacuum is created. International Publication No. WO/2004/097509, entitled “System for Producing Pasted Substrate” by Fujitsu Limited, and International Publication No. WO/2003/091970, entitled “Sticking Device for Flat Panel Substrate” by Shin-Etsu Engineering Co., Ltd., disclose examples substrate bonding apparatuses of this type.

During operation of these apparatuses, the TFT and CF substrates are pressurized in order to allow them to be bonded to each other. To accomplish bonding, two electrostatic chucks (ESC) are disposed in opposing relation to one another. The substrates are held by the electrostatic chucks. During bonding, the chucks are brought close to each other, while the parallelism of the chucks is precisely maintained. The process of bonding the substrates is then performed.

However, the electrostatic chucks used in these apparatuses are very expensive. Moreover, a polyimide film on the surface of each chuck is used to generate electrostatic force. Often, during use, this film is damaged by particles generated during the substrate bonding process.

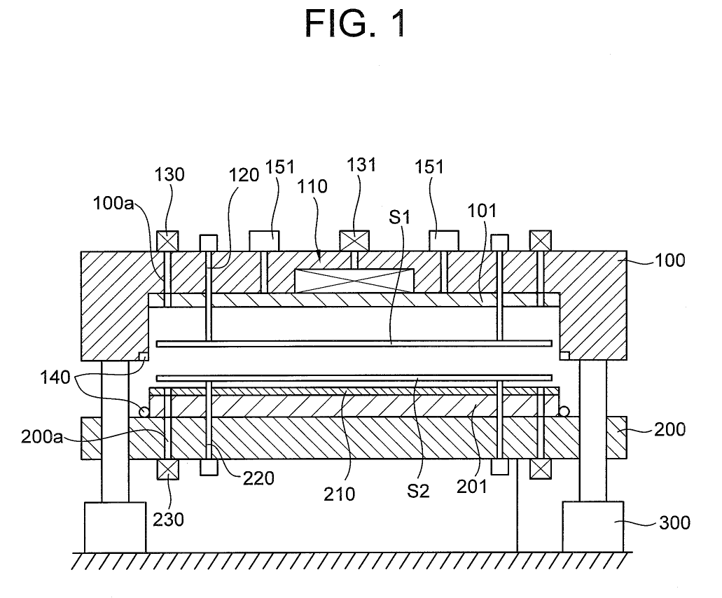

FIG. 1 shows one embodiment of another type of substrate bonding apparatus. This apparatus includes a first chamber 100 and a second chamber 200 on which a first substrate S1 and a second substrate S2 are respectively received. The second chamber is fixed to a base, and the first chamber is positioned over the second chamber and moves in up and down directions by a lift 300.

A first substrate chuck 110 holding the first substrate S1 is provided at the bottom of the first chamber. A second substrate chuck 210 on which the second substrate S2 is received is provided at the top of the second chamber. The first substrate chuck is installed on a first surface plate 101 in the first chamber, and the second substrate chuck is installed on a second surface plate 201 in the second chamber.

The second substrate chuck 210 may be an electrostatic chuck (ESC) holding the second substrate S2 by electrostatic force. Moreover, a plurality of lift pins 220 that pass through or otherwise penetrate the second substrate chuck 210 and the second surface plate 201 is provided in the second chamber.

The lift pins are lifted to receive the second substrate S2 when the second substrate S2 is carried in and lowered, so that the second substrate is received on second substrate chuck 210. When the first substrate Si at the top and the second substrate S2 at the bottom are bonded to form a panel, lift pins 220 lift the bonded panel in order to allow it to be discharged to the outside.

A camera 130 may also be included in the first chamber for photographing alignment marks on the first substrate S1 and second substrate S2. By imaging these alignment marks, a determination may be made as to whether the substrates S1 and S2 are located at accurate and aligned positions. The camera photographs the marks through a hole 100a passing through the first chamber. A light unit 230 is provided at the bottom of the second chamber 200 to provide light to the hole 200a, so that the camera 130 is able to better photograph the alignment marks.

The substrate bonding apparatus may also include a turbo molecular pump (TMP) or a dry pump for creating a vacuum in a process space formed when the first and second chambers are brought in close proximity to one another.

The first surface plate lift 151, adhesive lift 131, and lift 300 may be embodied as a linear actuator.

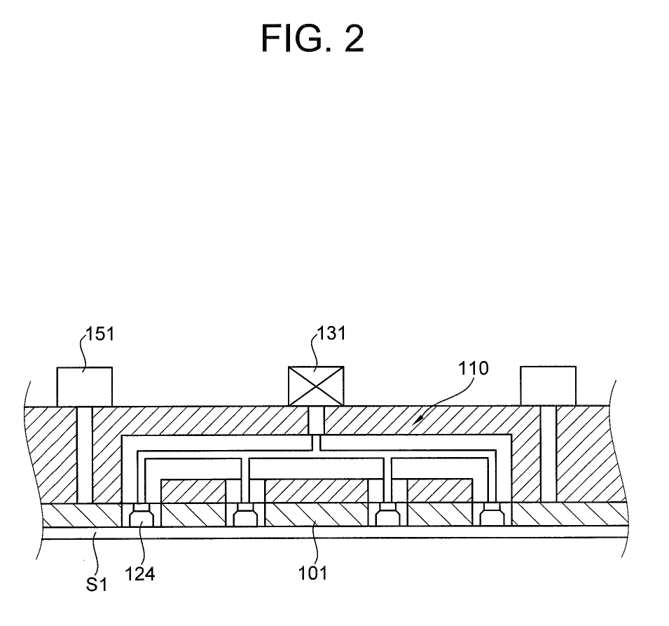

FIG. 2 shows an enlarged view of substrate chuck 110 used in the substrate bonding apparatus of FIG. 1. Substrate chuck 110 includes the first surface plate 101 on which the first substrate S1 is received, a first surface plate lift 151 for moving the first surface plate up and down, a plurality of adhesives 124 passing through or penetrating first surface plate 101 for adhering to the first substrate S1, and an adhesive lift 131 for moving the adhesives 124 in up and down directions.

The adhesives are arranged in the form of a matrix on first surface plate 101. By arranging the adhesives in a matrix, the adhesives may be easily maintained and repaired. The adhesives may be arranged in various forms and configurations according to a user's convenience, other than a matrix form.

Each adhesive 124 may be obtained by curing 10 to 75 parts by weight of an organopolysiloxane having alkenyl groups bonded to silicon atoms, 5 to 30 parts by weight of an organhydrogenpolysiloxane, and an addition-curable silicone rubber composition comprising an addition-curable catalyst. The adhesives may be formed by molding the silicone rubber composition by compression molding, slip casting, or injection molding. Otherwise, the adhesives may be formed by irradiating light on polymethylmethacrylate (PMMA), which is a kind of plastic, to form fine grooves with prominence and depression having a diameter of about 400 nm.

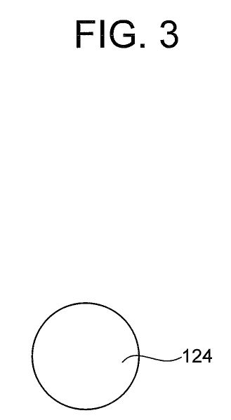

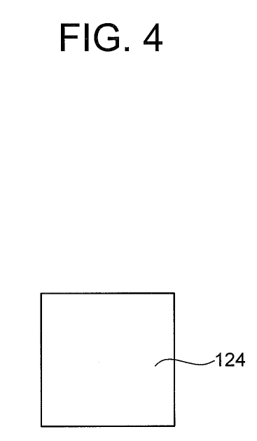

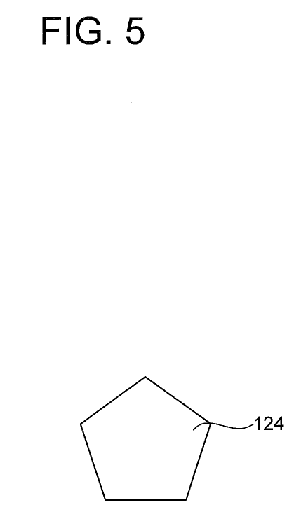

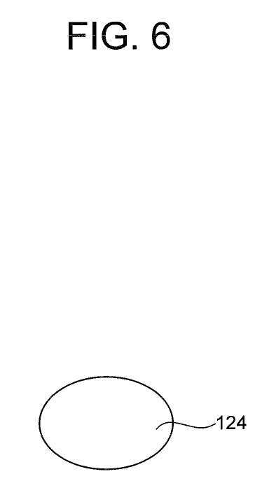

The adhesives may be formed in various shapes as shown in FIGS. 3 to 6. For example, the adhesives may be formed in a circular shape as shown in FIG. 3, a tetragonal shape as shown in FIG. 4, a pentagonal shape as shown in FIG. 5, or an oval shape as shown in FIG. 6.

Operation of the substrate bonding apparatus, and a substrate bonding method which may be performed in accordance with the embodiment of FIG. 1, will now be described.

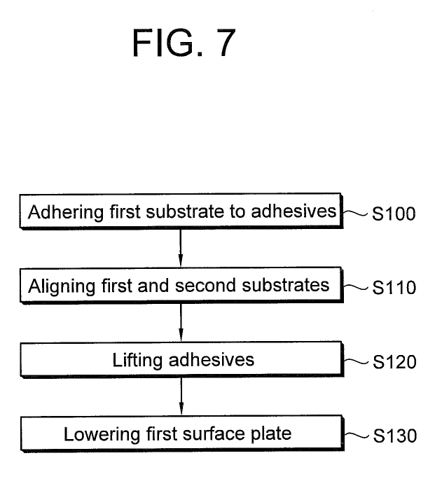

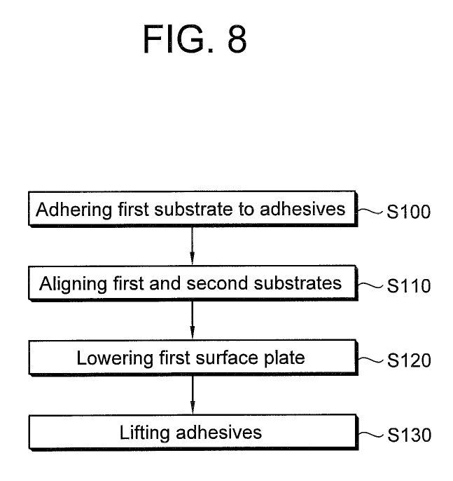

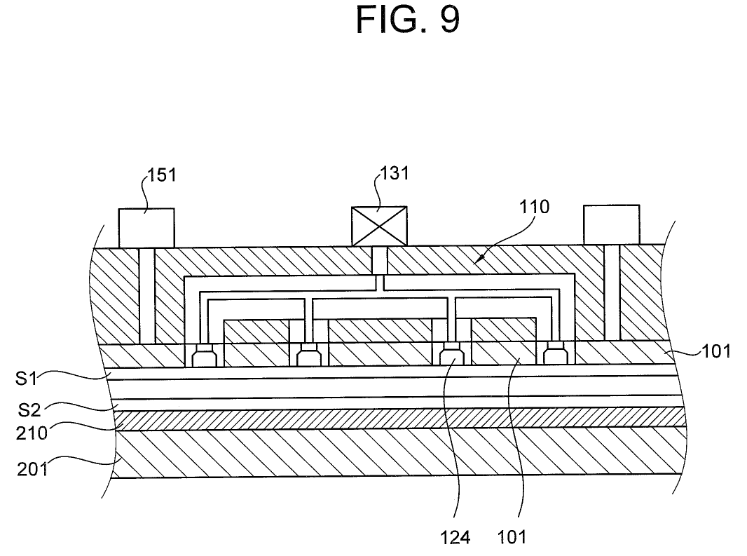

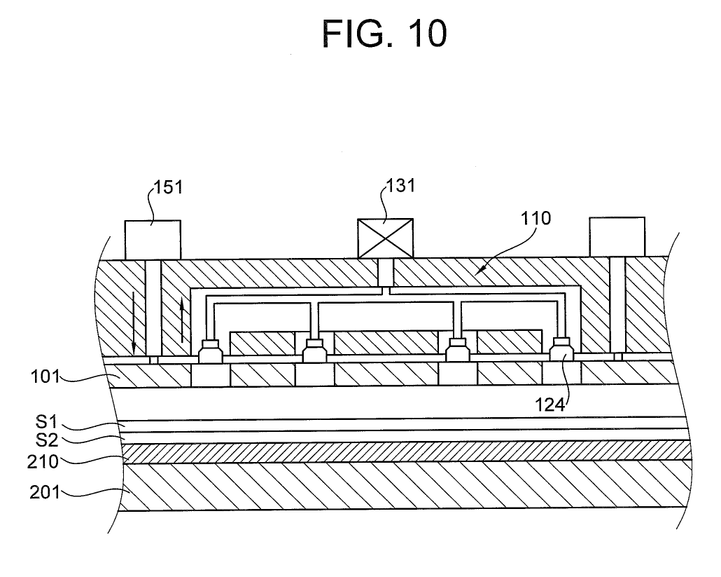

FIGS. 7 and 8 are flowcharts showing steps included in various embodiments of a substrate bonding method, and FIGS. 9 and 10 are diagrams showing the operation of the substrate chuck.

Initially, a robot (not shown) may carry the first substrate S1 in a space where the first chamber 100 and the second chamber 200 are spaced from each other. The adhesive lift 131 of the first chamber lowers the adhesives so that the first substrate S1 adheres to the adhesives (S100). The adhesive lift then lifts the adhesives with the first substrate S1.

Meanwhile, during reception of the first substrate S1, a vacuum chuck may receive the first substrate S1 and move up so that the first substrate S1 sticks to the adhesives. Lift 131 moves the adhesives 124 up and down. A plurality of adhesive lifts 131 may be used to perform this function in another embodiments.

After the first substrate S1 is carried in, the second substrate S2 is carried by the robot. The lift pins 220 are lifted to receive the second substrate S2. Once the lift pins support the second substrate S2, the robot moves out of the chamber. The lift pins are then moved so that the second substrate S2 is received on the second surface plate 201. When the second substrate S2 is received on the second surface plate, the second substrate S2 is adhered to the second substrate chuck 210 by electrostatic force.

Subsequently, the first chamber 100 is lowered by lift 300 toward the second chamber 200, thereby forming a process space. A vacuum is created in the process space by the dry pump or turbo molecular pump. At this time, the first and second substrates S1 and S2 are roughly aligned. The rough alignment may be performed, for example, by photographing the alignment marks by the camera in such a state that the distance between the two substrates is enlarged. The alignment may then be performed by a UVW alignment apparatus (not shown) that is installed at the bottom portion of a surface plate. However, the alignment marks may not be matched exactly because the distance between the substrates is enlarged.

After rough alignment between the substrates is completed, a precise alignment between the substrates S1 and S2 is performed to complete the alignment (S110). This may be accomplished, for example, by aligning the UVW stage where the substrates are arranged close to each other. At this time, the alignment marks may be more precisely matched because the distance between the substrates is arranged close to each other. This alignment method or other known alignment methods may be used in the bonding apparatus.

After completion of the alignment step, the process space is placed in a vacuum state and the first and second substrates S1 and S2 are brought close to each other (see FIG. 9).

In this state, the adhesives 124 are lifted by adhesive lift 131 and first surface plate 101 is lowered by the first surface plate lift 151, such that first substrate S1 is separated from the adhesives (see FIG. 10). Accordingly, the first substrate is separated from the adhesives and dropped onto the second substrate S1, such that the first substrate S1 and the second substrate S2 are bonded to each other (S120 and S130).

Bonding may be aided by coating at least one of the substrates with an adhesive agent in advance. This agent may cause the substrates to adhere to one another after a curing process is performed using, for example, UV light. Alternatively, a heat curing technique may be used for increasing the strength of the bond between the substrates. These or other known bonding techniques may be used during processing.

The priority order in which the adhesives and first surface plate 101 are moved up and down may be varied. For example, according to one embodiment of a substrate separating method, the adhesives are lifted first (S120) and the first surface plate 101 is lowered while the adhesives are lowered (S130) as shown in FIG. 7. According to another embodiment, the first surface plate is lowered first (S120) and the adhesives are lifted while the first surface plate is lowered (S130). According to another embodiment, the adhesives and first surface plate are simultaneously moved in opposite directions.

When the first substrate S1 and second substrate S2 are bonded to each other, nitrogen is injected into the process space so that the process space is in an atmospheric pressure state. With the injection of nitrogen, the first and second substrates are more firmly bonded to each other. After completion of the final bonding process, the first chamber and second chamber are spaced from each other, and the lift pins of the second chamber are moved up to lift the bonded panel. The robot then enters the process space and removes the bonded panel.

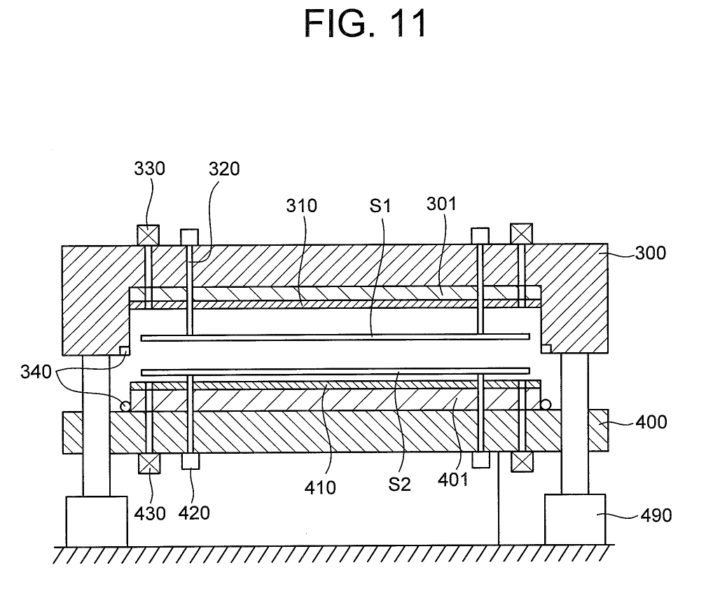

FIG. 11 shows another embodiment of a substrate bonding apparatus. This apparatus includes a first chamber 300 and a second chamber 400 in which a first substrate S1 and a second substrate S2 are respectively received. The second chamber is fixed to a base and the first chamber is moved up and down by a lift 490.

A first substrate chuck 310 on which the first substrate S1 is received is in the first chamber, and a second substrate chuck 410 on which the second substrate S2 is received is in the second chamber. The first substrate chuck is installed on a first surface plate 301 in the first chamber, and the second substrate chuck 410 is installed on a second surface plate 401 in the second chamber. The first substrate chuck may hold the first substrate by van der Waals force and the second substrate chuck may hold the second substrate by electrostatic force.

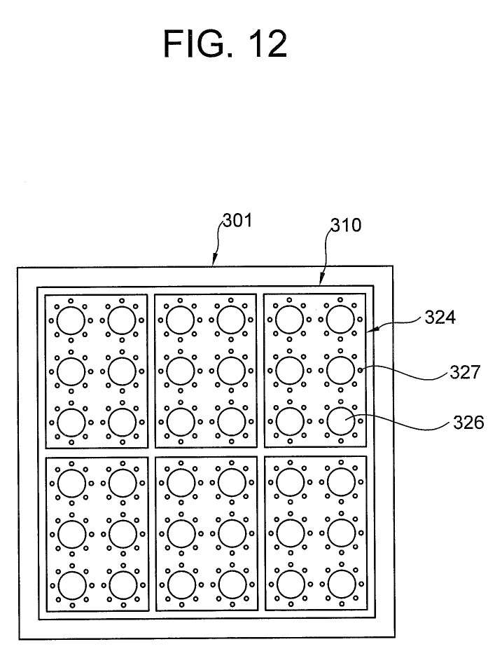

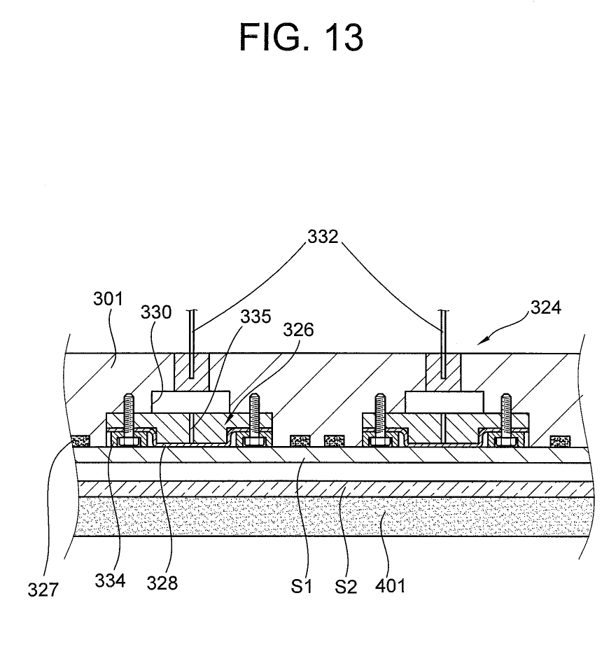

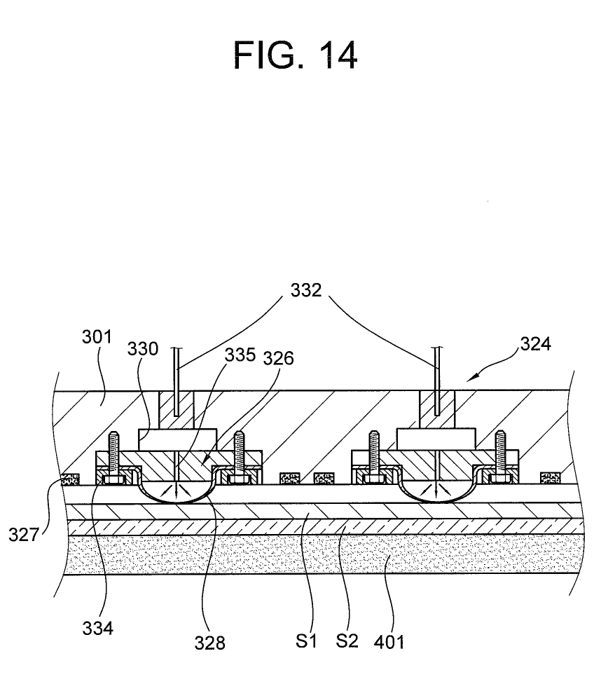

FIG. 12 shows a plan view of the first substrate chuck and FIGS. 13 and 14 show the configuration and operation of the substrate chuck. As shown in FIG. 12, the first substrate chuck includes a plurality of chucking units 324 arranged in the form of a matrix on the first surface plate 301. When a plurality of chucking units is arranged in the form of a matrix, it is possible to facilitate the maintenance and repair of the first substrate chuck.

As shown in FIGS. 13 and 14, each of the chucking units includes a plurality of adhesives 327 for holding the first substrate S1 by adhesive force and a plurality of separation units 326 for separating the first substrate S1 from the adhesives.

The separation unit 326 includes an expansion member 328 that expands to contact the adhesion surface of the first substrate S1 held by the adhesives, an installation unit 330 in which the expansion member is installed to the side of the adhesion surface to form an airtight space, a heating unit 332 for heating air in the installation unit, and a supply hole 335 for supplying heated air to the expansion member 328. The expansion member may be formed of any elastic material. For example, the expansion member may be a diaphragm and the heating unit 332 may be a hot wire.

A support member 334 is provided inside the installation unit 330 to prevent the expansion member from being deformed when the expansion member is returned to its original state. The support member supports the expansion member, which is repeatedly expanded and contracted according to the rise and fall of the temperature of the air in the installation unit, and serves to maintain the reliability of operation accuracy during repetitive use.

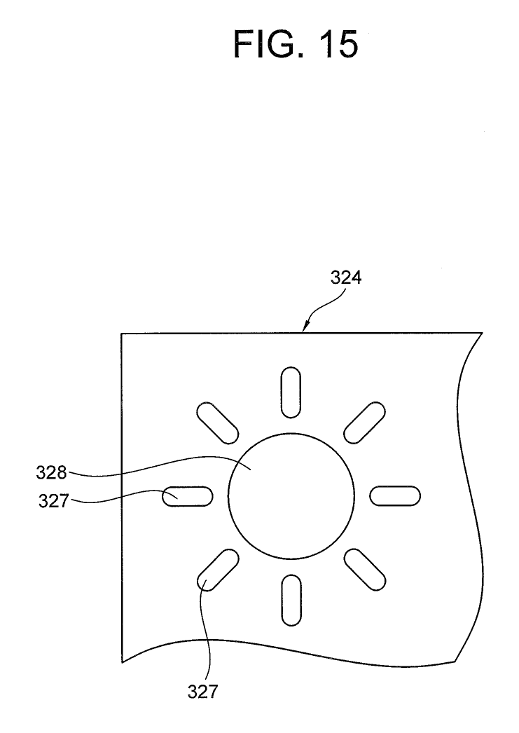

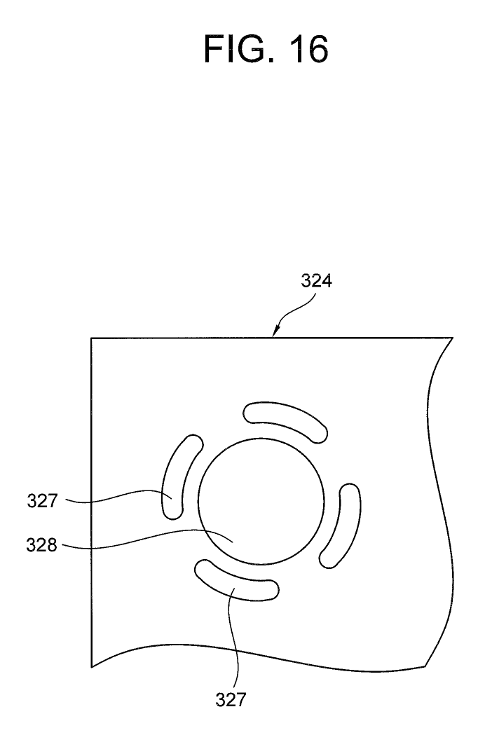

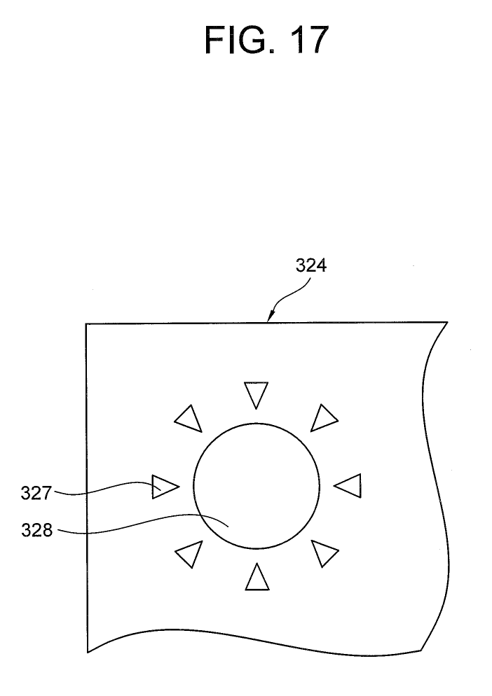

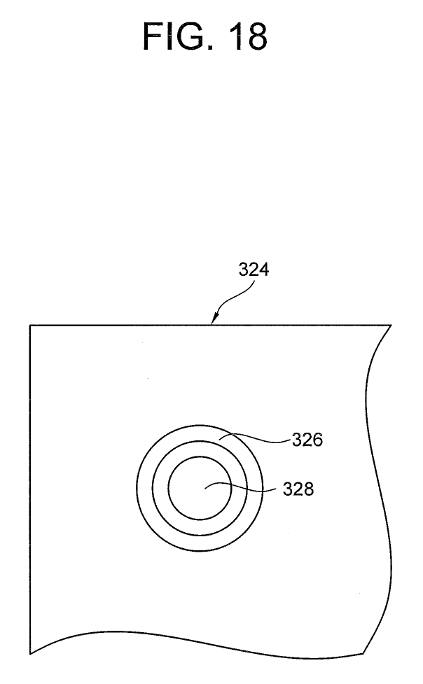

The adhesives 327 may be arranged in a circular pattern on an outer circumference of the separation unit 326. Each adhesive may be formed, for example, in a substantially rectangular shape, an arc shape, or a triangular shape having a width that narrows toward the expansion member as shown in FIGS. 15 to 17. Otherwise, as shown in FIG. 18, the adhesive may be provided at a central location and the separation unit 328 may be disposed around a circumference of the adhesive. In other embodiments, a combination of these patterns may be realized.

The second substrate chuck 410 may be an electrostatic chuck (ESC) holding second substrate S2 by electrostatic force. A plurality of lift pins 420 passing through second surface plate 401 and second substrate chuck 410 is provided at the bottom of the second surface plate.

The lift pins are lifted to receive the second substrate S2 when the second substrate is carried in and lowered, so that the second substrate is received on second substrate chuck 410. When the first and second substrates are bonded to form a bonded panel, the lift pins lift the bonded panel so that it can be discharged.

A camera 330, for photographing alignment marks on the first and second substrates is used to determine whether the substrates are located at accurate positions, is provided in the first chamber. The camera photographs the marks through a hole that passes through the first chamber. A lighting unit 430 at the bottom of the second chamber provides light to the camera, so that the camera can better photograph the alignment marks.

A turbo molecular pump (TMP) or a dry pump, for creating a vacuum in a process space formed when the first chamber and the second chamber are close to each other, is connected to the first chamber and the second chamber.

Operation of the substrate bonding apparatus in accordance with the present embodiment will now be described. Initially, a robot may carry the first substrate S1 in a space where the first chamber 300 and the second chamber 400 are spaced from each other. Then, a vacuum chuck 320 in the first chamber is lowered to hold the first substrate S1 and then lifted. The first substrate is adhered to adhesives 327 on the first surface plate 301 when the first substrate is held and lifted by vacuum chuck 320.

Then, the second substrate S2 is carried by the robot. To receive the second substrate, lift pins 420 are lifted to support the second substrate and the robot moves out of the chamber. The lift pins are then lowered so that the second substrate is received on second surface plate 401 and held by second substrate chuck 410.

Subsequently, the first chamber 300 is moved by lift 490 and placed closely to the second chamber 400, thereby forming a process space. When the process space is formed, a vacuum is created in the process space by the dry pump or turbo molecular pump. At this time, the first surface plate 301 is lowered to perform a rough alignment between the first substrate S1 and second substrate S2. After completion of the rough alignment, a precise alignment between the substrates is performed and thus the substrate alignment is completed. The rough and precise alignment may be performed as previously described.

After alignment, the process space is placed in a vacuum state when the first substrate S1 and second substrate S2 are brought close to each other as shown in FIG. 11. Next, when expansion members 328 expand as shown in FIG. 12, the first substrate S1 is separated from adhesives 327 and dropped onto the second substrate S2, such that the first substrate S1 and the second substrate S2 are bonded to each other. Bonding may be aided according to any of the techniques previously described, e.g., by an adhesive followed by curing.

When the first substrate S1 and second substrate S2 are bonded to each other, air is discharged from chambers 300 and 400 to create an atmospheric pressure state. N2 gas may be supplied from the first chamber so that the first and second substrates are more firmly bonded to each other.

After completion of the final bonding process, the first and second chambers are spaced from each other and lift pins 420 of the second chamber are moved up to lift the bonded panel. The robot then enters the process space to remove the bonded panel, thus completing the bonding process.

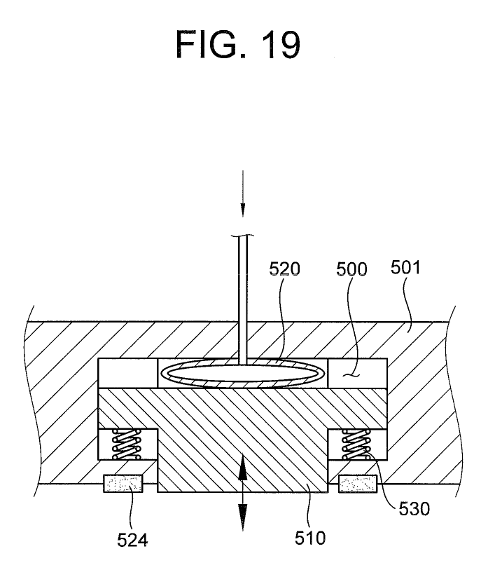

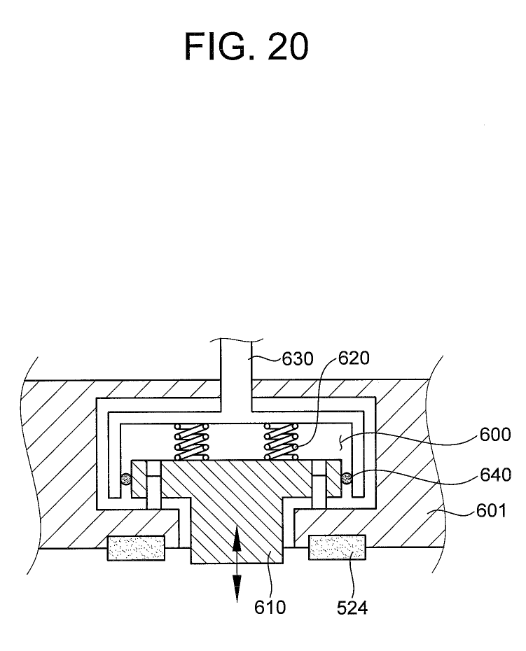

FIGS. 19 and 20 show other examples of a substrate chuck that may be used with the foregoing embodiments of the substrate bonding apparatus.

In the example shown in FIG. 19, the substrate chuck includes an installation unit 500 formed on a surface plate 501, a separation block 510 provided in the installation unit 500 to slidably move, a diaphragm 520 disposed inside the installation unit 500 to move the separation block 510 to the substrate, and a spring 530 for supporting both ends of the separation block to return the separation block to the inside of the installation unit. During separation of the substrate, the substrate chuck injects air into the inside of the diaphragm to be expanded. When the diaphragm expands, the separation block is pushed out of the installation unit to separate the substrate from adhesives 524. After substrate separation, the air supplied to the diaphragm is cut off. As a result, the springs 530 return the separation block to the inside of the installation unit.

In the example shown in FIG. 20, the substrate chuck includes an installation unit 600 formed on a surface plate 601, a separation block 610 provided in the installation unit to slidably move, a press unit 630 disposed inside the installation unit to move the separation block to the substrate, and a spring 620 disposed between the separation block and the press unit to return the separation block simultaneously when the press unit is returned. Moreover, an O-ring 640 is provided between both ends of the press unit and the side of the separation block.

The press unit 630 of the substrate chuck is moved up and down by a driving source such as a cylinder. When the press unit is lowered, separation block 610 is pushed out to the bottom of the installation unit by the press unit to separate the substrate from adhesives 524. When the press unit moves up, the separation block is lifted by the restoring force of the spring and returned to the inside of the installation unit.

The foregoing embodiments therefore provide a substrate chuck formed of an adhesive having an adhesive force, a substrate bonding apparatus using the substrate chuck, a substrate separating method, and a substrate bonding method.

According to one embodiment, a substrate bonding apparatus includes a first chamber including a first surface plate on which a first substrate is received; a surface plate lift for lifting the first surface plate; a second chamber including a second surface plate on which a second substrate to be bonded to the first substrate is received; an adhesive penetrating the first surface plate and adhering the first substrate; and an adhesive lift for independently lifting the adhesive. The adhesive may be a plurality of adhesives, and the adhesive lift may lift the plurality of adhesives at the same time.

According to another embodiment, a substrate chuck includes a surface plate on which a substrate is received; a surface plate lift for lifting the surface plate; an adhesive penetrating the surface plate and adhering the substrate; and an adhesive lift for independently lifting the adhesive. The adhesive may be a plurality of adhesives, and the adhesive lift may lift the plurality of adhesives at the same time.

According to another embodiment, a substrate separating method includes lowering a surface plate to separate a substrate from the surface plate; and lifting an adhesive penetrating the surface plate and adhering the substrate. The adhesive may be lifted while the surface plate is lowered. The surface plate may be lowered while the adhesive is lifted. The adhesive and the surface plate may be simultaneously moved up and down in directions opposite to each other.

According to another embodiment, a substrate bonding method includes adhering a first substrate to an adhesive of a first substrate; adhering a second substrate to a second surface plate to align the first substrate and the second substrate; lowering the first surface plate to separate the first substrate from the first surface plate; and lifting the adhesive penetrating the first surface plate and adhering the first substrate to drop the first substrate onto the second substrate to be bonded to each other. The adhesive may be lifted while the first surface plate is lowered. The first surface plate may be lowered while the adhesive is lifted. The adhesive and the first surface plate may be simultaneously moved up and down in directions opposite to each other.

According to another embodiment, a substrate bonding apparatus includes a first chamber in which a first substrate is received; a second chamber, spaced from the first chamber, in which a second substrate to be bonded to the first substrate is received; an adhesive provided in the first chamber to adhere the first substrate by adhesive force; and a separation unit provided in the first chamber to separate the first substrate from the adhesive. The adhesive may be formed around the circumference of the separation unit. The separation unit may be formed around the circumference of the adhesive.

According to another embodiment, a substrate chuck includes a surface plate including an adhesive for adhering a substrate; and a separation unit provided on the surface plate to separate the substrate from the surface plate. The separation unit may include an expansion member expanding to an adhesion surface of the substrate adhered by the adhesive, an installation unit, in which the expansion member is installed, formed on the surface plate to form an airtight space, and a heating unit for heating air in the installation unit to expand the expansion member. The expansion member may be a diaphragm, and the heating unit may be a hot wire. A support member may be provided in the installation unit to prevent the expansion member from being deformed when the expansion member is returned.

The separation unit may include an installation unit formed on the surface plate, a separation block provided in the installation unit to slidably move, a diaphragm disposed inside the installation unit to move the separation block to the substrate, and a spring for supporting both ends of the separation block to return the separation block to the inside of the installation unit.

The separation unit may include an installation unit formed on the surface plate, a separation block provided in the installation unit to slidably move, a press unit disposed inside the installation unit to move the separation block to the substrate, and a spring disposed between the separation block and the press unit to return the separation block simultaneously when the press unit is returned.

The adhesive may be formed around the circumference of the separation unit. The adhesive may be formed in an oval shape, and a plurality of adhesives may be provided around the circumference of the separation unit in a radial shape. The adhesive may be formed in a curved oval shape and arranged to surround the circumference of the separation unit. The adhesive may be formed in a triangular shape, and a plurality of adhesives may be provided such that each vertex of the plurality of adhesives is disposed around the circumference of the separation unit. The separation unit may be provided around the circumference of the adhesive.

In accordance with the embodiments described herein, it is therefore possible to fabricate a substrate chuck at lower cost than conventional electrostatic chucks, and it is also possible to better facilitate maintenance and repair, thereby improving the manufacturing and operating efficiencies of the substrate bonding apparatus.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments of the present invention have been described with reference to a number of illustrative embodiments thereof, it should be understood that numerous other modifications and embodiments can be devised by those skilled in the art that will fall within the spirit and scope of the principles of this invention. More particularly, reasonable variations and modifications are possible in the component parts and/or arrangements of the subject combination arrangement within the scope of the foregoing disclosure, the drawings and the appended claims without departing from the spirit of the invention. In addition to variations and modifications in the component parts and/or arrangements, alternative uses will also be apparent to those skilled in the art.

What is claimed is:

1. A substrate bonding apparatus comprising:
a first chamber including a first surface plate on which a first substrate is received;
a surface plate lift for lifting the first surface plate;
a second chamber including a second surface plate on which a second substrate to be bonded to the first substrate is received;
at least one adhesive included with the first surface plate to adhere to the first substrate; and
an adhesive lift for independently lifting the adhesive.

2. The apparatus of claim 1, further comprising:
a plurality of adhesives, the adhesive lift lifting the plurality of adhesives at substantially the same time.

3. The apparatus of claim 1, wherein the first surface plate is lowered so that the first substrate is allowed to be separated from the first surface plate, and wherein the first substrate is separated by separating the first substrate from the at least one adhesive.

4. The apparatus of claim 3, wherein the at least one adhesive is lifted while the first surface plate is lowered to separate the first substrate.

5. The apparatus of claim 3, wherein the first surface plate is lowered while the at least one adhesive is lifted to separate the first substrate.

6. The apparatus of claim 3, wherein the at least one adhesive and the first surface plate are simultaneously moved up and down in directions opposite to each other to separate the first substrate.

7. A substrate bonding method comprising:
adhering a first substrate to an adhesive of a first surface plate;
adhering a second substrate to a second surface plate, so that the first substrate and the second substrate are in alignment;
separating the first substrate from the first surface plate; and
lifting the adhesive included with the first surface plate to allow the first substrate to drop onto the second substrate to allow the first and second substrates to be bonded to each other.

8. The method of claim 7, wherein the adhesive is lifted while the first surface plate is lowered to separate the first substrate.

9. The method of claim 7, wherein the first surface plate is lowered while the adhesive is lifted to separate the first substrate.

10. The method of claim 7, wherein the adhesive and the first surface plate are simultaneously moved up and down in directions opposite to each other to separate the first substrate.

11. A substrate chuck comprising:
a surface plate including an adhesive for adhering a substrate; and
a separation unit provided on the surface plate to separate the substrate from the surface plate.

12. The substrate chuck of claim 11, wherein the separation unit comprises:
an expansion member expanding to an adhesion surface of the substrate adhered by the adhesive;
an installation unit, in which the expansion member is installed, formed on the surface plate to form an airtight space; and
a heating unit for heating air in the installation unit to expand the expansion member.

13. The substrate chuck of claim 12, wherein the expansion member includes a diaphragm and the heating unit includes a hot wire.

14. The substrate chuck of claim 12, wherein a support member is provided in the installation unit to prevent the expansion member from being deformed when the expansion member returns to an unexpanded position.

15. The substrate chuck of claim 11, wherein the separation unit comprises:
an installation unit formed on the surface plate;
a separation block provided in the installation unit to slidably move;
a diaphragm disposed inside the installation unit to move the separation block to the substrate; and
a spring for supporting both ends of the separation block to return the separation block to the inside of the installation unit.

16. The substrate chuck of claim 11, wherein the separation unit comprises:
an installation unit formed on the surface plate;
a separation block provided in the installation unit to slidably move;
a press unit disposed inside the installation unit to move the separation block to the substrate; and
a spring disposed between the separation block and the press unit to return the separation block simultaneously when the press unit is returned.

17. The substrate chuck of claim 11, wherein the adhesive is formed around a circumference of the separation unit.

18. The substrate chuck of claim 11, wherein the adhesive has substantially one of an oval shape or a triangular shape.

19. The substrate chuck of claim 18, wherein a plurality of adhesives having one of an oval shape or triangular shape is provided such that each vertex of the plurality of adhesives is disposed around a circumference of the separation unit.

20. The substrate chuck of claim 11, wherein a plurality of adhesives is provided around a circumference of the separation unit in a radial direction.
